(19) United States
(12) Patent Application Publication
(10) Pub. No.: US 2013/0002861 A1
(43) Pub. Date: Jan. 3, 2013

(54) CAMERA DISTANCE MEASUREMENT DEVICE

(76) Inventor: Tatsuya Mitsugi, Tokyo (JP)

(21) Appl. No.: 13/634,271

(22) PCT Filed: Jun. 7, 2010
(86) PCT No.: PCT/JP2010/003785

§ 371 Date: Sep. 12, 2012

(51) Int. Cl. H04N 7/18

(52) U.S. Cl. 348/135; 348/E07.085

(57) ABSTRACT

A camera distance measurement device displays an image in which a plurality of graduation lines which are arranged in the form of a grid with respect to a vehicle is superimposed on a camera image which is captured by a camera mounted to the vehicle on a display unit, and estimates a distance in a direction of the width of the vehicle, and a distance in a direction of the capturing by the camera from a unit distance defined for each grid side of the graduation lines.

### FIELD OF THE INVENTION

The present invention relates to a camera distance measurement device for measuring the distance to an object in a camera image by using, for example, an in-vehicle camera.

### BACKGROUND OF THE INVENTION

For example, patent reference 1 discloses a device which implements a distance measurement based on an arrival state of light arriving at an object by using still images close to each other with respect to time, each of the still images including an image which is captured by applying light to the object. However, because still images different with respect to time are used according to a conventional technology represented by the technology disclosed in patent reference 1, a temporal displacement may occur in an object in the case of using either a moving image or an image captured by a camera mounted in a moving object, such as an in-vehicle camera which moves as a vehicle travels. Further, it is necessary to separately prepare a mechanism exclusively used for applying light to an object.

The present invention is made in order to solve the above-mentioned problems, and it is therefore an object of the present invention to provide a camera distance measurement device which can measure the distance to an object in a camera image.

### RELATED ART DOCUMENT

### Patent Reference

Patent reference 1: Japanese Unexamined Patent Application Publication No. 2004-328657

### SUMMARY OF THE INVENTION

In accordance with the present invention, there is provided a camera distance measurement device for displaying an image in which a plurality of graduation lines which are arranged in a form of a grid with respect to a vehicle are superimposed on a camera image which is captured by a camera mounted to the vehicle on a display unit to measure a distance in a direction of the width of the vehicle and a distance in a direction of the capturing by the camera from a unit distance defined for each grid side of the graduation lines, the camera distance measurement device including: a parameter storage unit for storing mounting information showing a mounting position and a mounting angle at and with which the camera is mounted to the vehicle, angle of view information showing an angle of view of the camera, projection method information showing a projection method for use in a lens of the camera, and screen size information showing a screen size of the display unit as parameter information; a distance measurement arithmetic operation unit for performing a process of correcting distortion of the lens of the camera on position coordinates in real space of each of grid points defined by the plurality of graduation lines which are arranged in the form of a grid and at intervals of the unit distance, and for transforming the position coordinates of each of the grid points in which the distortion of the lens has been corrected into position coordinates in the camera image on a basis of the mounting information, the angle of view information, the projection method information, and the screen size information which are read from the parameter storage unit to create graduation line information; a line drawing unit for arranging the plurality of graduation lines on a basis of the graduation line information in such a way that they are intersecting at right angles in a form of a grid to create a graduation line image; an image correcting unit for performing a correcting process of removing the distortion of the lens of the camera in the camera image and distortion caused by the projection method; and an image superimposing unit for superimposing the graduation line image created by the line drawing unit on the camera image corrected by the image correcting unit to output the camera image on which the graduation line image is superimposed to the display unit.

Further, in accordance with the present invention, there is provided a camera distance measurement device for displaying a camera image which is captured by a camera mounted to a vehicle on a display unit to measure a distance from a position in the camera image to the vehicle, the camera distance measurement device including: a parameter storage unit for storing mounting information showing a mounting position and a mounting angle at and with which the camera is mounted to the vehicle, angle of view information showing an angle of view of the camera, projection method information showing a projection method for use in a lens of the camera, and screen size information showing a screen size of the display unit as parameter information; an in-screen position determining unit for determining a position in the camera image displayed on the display unit; a distance measurement arithmetic operation unit for performing a process of correcting distortion of the lens of the camera on coordinates of the position in space of the camera image determined by the in-screen position determining unit, and for transforming the position coordinates in which the distortion of the lens has been corrected into position coordinates at a predetermined height from a ground surface in real space on a basis of the mounting information, the angle of view information, the projection method information, and the screen size information which are read from the parameter storage unit to create position information; and an output unit for outputting a distance from the position in the camera image determined by the in-screen position determining unit to the vehicle on a basis of the position information.

In accordance with the present invention, there is provided an advantage of being able to measure a distance in a direction of the width of the vehicle and a distance in a direction of the capturing by the camera from the unit distance defined for each grid block side of the graduation lines, and another advantage of being able to measure the distance to an object in the camera image.

### BRIEF DESCRIPTION OF THE FIGURES

FIG. 1 is a block diagram showing the structure of a camera distance measurement device in accordance with Embodiment 1 of the present invention;

FIG. 2 is a view showing an example of an object image pattern of graduation lines in real space which is calculated by a graduation line creating unit;

FIG. 3 is a view showing an example of a graduation line image;

FIG. 4 is a view showing another example of the graduation line image;

FIG. 5 is a block diagram showing the structure of a camera distance measurement device in accordance with Embodiment 2 of the present invention;

FIG. 6 is a block diagram showing the structure of a camera distance measurement device in accordance with Embodiment 3 of the present invention;

FIG. 7 is a view showing an example of a graduation line image in accordance with Embodiment 3; and

FIG. 8 is a block diagram showing the structure of a camera distance measurement device in accordance with Embodiment 4 of the present invention.

### EMBODIMENTS OF THE INVENTION

Hereafter, in order to explain this invention in greater detail, the preferred embodiments of the present invention will be described with reference to the accompanying drawings.

### Embodiment 1

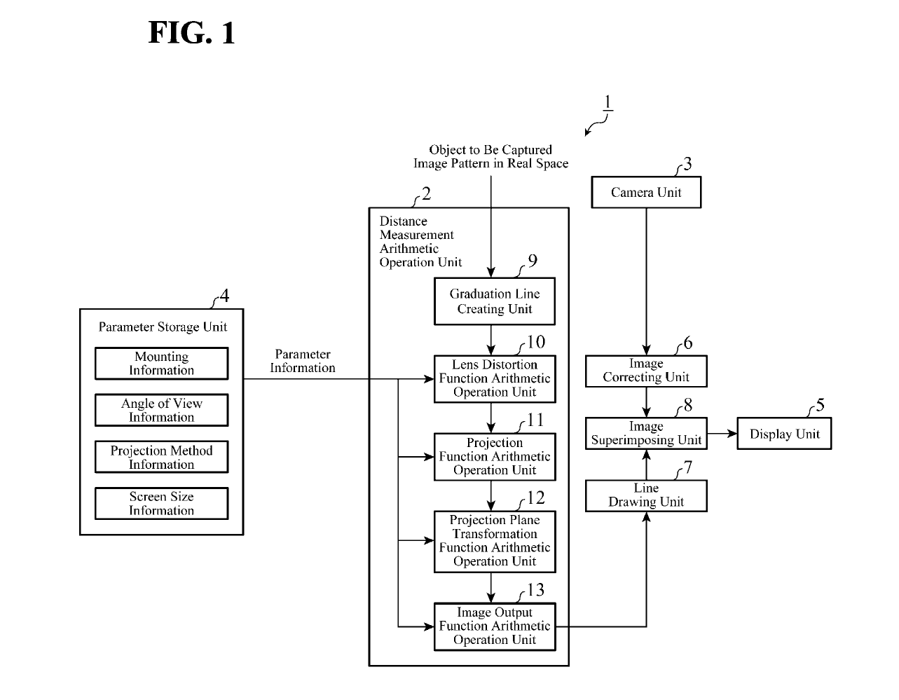

FIG. 1 is a block diagram showing the structure of a camera distance measurement device in accordance with Embodiment 1 of the present invention. Referring to FIG. 1, the camera distance measurement device 1 is provided with a distance measurement arithmetic operation unit 2, a camera unit 3, a parameter storage unit 4, a display unit 5, an image correcting unit 6, a line drawing unit 7, and an image superimposing unit 8. The distance measurement arithmetic operation unit 2 is a component for calculating a graduation line image showing a distance from a vehicle, and is provided with a graduation line creating unit 9, a lens distortion function arithmetic operation unit 10, a projection function arithmetic operation unit 11, a projection plane transformation function arithmetic operation unit 12, and an image output function arithmetic operation unit 13.

The camera unit 3 includes a camera for capturing an image of an area surrounding the vehicle (for example, an area behind the vehicle), and transmits the camera image captured by this camera to the image correcting unit 6. The image correcting unit 6 is a component for making a predetermined correction to the camera image received from the camera unit 3, and outputs the image corrected thereby to the image superimposing unit 8. An image in which an image of graduation lines which defines distances from the vehicle and which is created by the line drawing unit 7 is superimposed on the camera image from the image correcting unit 6 is displayed on the display unit 5. The driver of the vehicle is enabled to visually recognize the distance between the vehicle which the user is driving and an obstacle on the basis of the graduation lines in the image.

The parameter storage unit 4 is disposed in such a way that the distance measurement arithmetic operation unit 2 can read data from the parameter storage unit, and stores mounting information, angle of view information, projection method information, and screen size information. The mounting information shows how the camera is mounted to the vehicle. More specifically, the mounting information shows the mounting position and the mounting angle at and with which the camera is mounted in the vehicle. The information showing the mounting position includes the height of the camera mounted with respect to the vehicle and the displacement of the camera from the center of the vehicle in a direction of the width of the vehicle. The angle of view information is angle information shows a range of angles during which an object can be captured by the camera of the camera unit 3, and includes either a maximum horizontal angle of view Xa and a maximum vertical angle of view Ya of the camera, or a diagonal angle of view of the camera. The projection method information shows a projection method for use in the lens of the camera of the camera unit 3. Because a fish-eye lens is used as the lens of the camera in Embodiment 1, information showing either one of stereographic projection, equidistant projection, equisolidangle projection and orthogonal projection is provided as the projection method information. The projection method information constructs camera correction information. The screen size information shows a screen size in an image output, i.e. a display range at the time of display of an image by the display unit 5, and includes a maximum horizontal drawing pixel size Xp and a maximum vertical drawing pixel size Yp of the display unit 5.

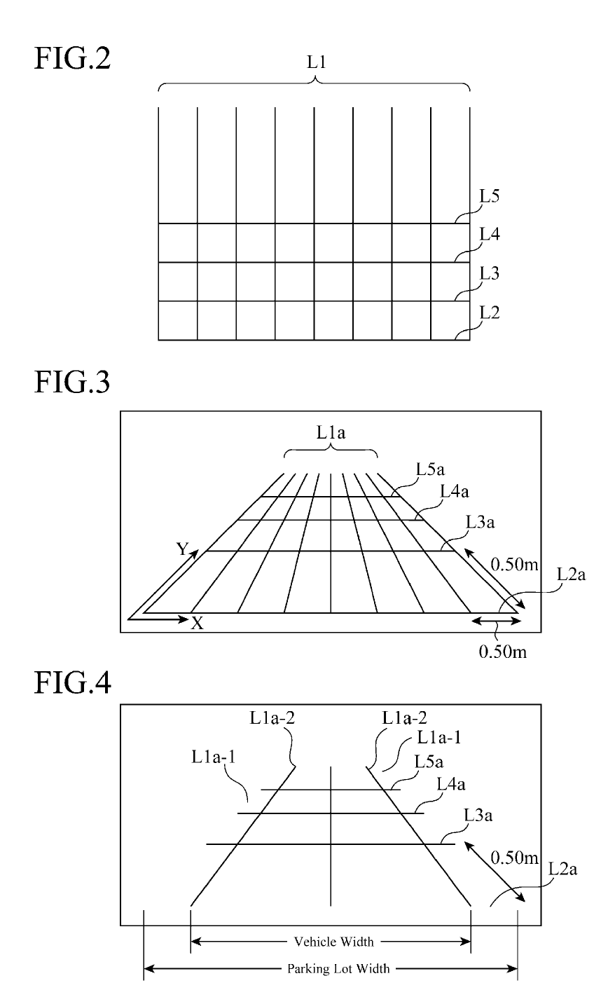

Next, the operation of the camera distance measurement device will be explained. The graduation line creating unit 9 of the distance measurement arithmetic operation unit 2 calculates the positions at which the graduation lines to be displayed on the display unit 5 are to be drawn, i.e. graduation line information showing the positions of the graduation lines in the camera image captured by the camera on the basis of the preset graduation line size information. Hereafter, a case in which the camera unit 3 is mounted to a rear portion of the vehicle, and an area behind the vehicle is defined as an image capture range will be explained. FIG. 2 is a view showing an example of an object image pattern of the graduation lines in real space which is calculated by the graduation line creating unit. The object image pattern of the graduation lines are graduation lines arranged in the form of a grid which are set up virtually on a ground surface extending in a direction of the capturing by the camera (in a backward direction behind the vehicle). Referring to FIG. 2, straight lines L1 are graduation lines running at right angles to a direction of the width of the vehicle, and straight lines L2 to L5 are graduation lines running in parallel with the direction of the width of the vehicle. The straight lines L1 intersect with each of the straight lines L2 to L5 in such a way that a plurality of grid blocks are formed. Each grid block has a side extending in a direction of the length of each straight line L1 and having a predetermined length (e.g. 0.50 meters) in the real space, and a side extending in a direction of the length of each of the straight lines L2 to L5 and having a predetermined length (e.g. 0.50 meters) in the real space.

The graduation line creating unit 9 determines the length in the direction of the width of the vehicle in which the graduation line group consisting of the straight lines L1 is aligned on the basis of graduation line size information, defines the graduation line groups in the form of such a grid as shown in FIG. 2, and determines the coordinates of the point of intersection between each of the straight lines L1 and each of the other straight lines. Each of the next-stage function arithmetic operation units 10 to 13 performs a function having the same influence as that exerted on the image at the time when captured by the camera on the coordinates, and the line drawing unit 7 creates a graduation line image on the basis of the graduation line information about the coordinates of the position of each point of intersection which are acquired as computed results. As a result, an image in which the graduation lines are superimposed on the camera image without being displaced is displayed on the display unit 5. Hereafter, for the sake of simplicity, the coordinates (x, y) of one point of intersection included in the coordinates of the points of intersection of the graduation lines shown in FIG. 2 which are virtually set up on a ground surface behind the vehicle will be explained as an example. For example, the coordinates (x, y) can be defined as a position in a rectangular coordinate system which has, as its point of origin, a point on the ground surface behind the vehicle which is located at a predetermined distance from the vehicle.

The lens distortion function arithmetic operation unit 10 performs a lens distortion function i on the coordinates (x, y) showing a point of intersection of graduation lines calculated by the graduation line creating unit 9 to transform the coordinates (x, y) into coordinates (i (x), i (y)) which has undergone lens distortion. The lens distortion function i represents the distortion which the camera image which is acquired when the camera of the camera unit 3 has captured an object undergoes due to the shape of the lens of the camera. For example, the lens distortion function i can be determined by using the Zhang model related to the lens distortion. In this model, the lens distortion is modeled as radial distortion, and, when the coordinates which have not been affected by the lens distortion are expressed as (x, y), the coordinates which have been affected by the lens distortion are expressed as (i(x) and i (y)), the normalized coordinates which have not been affected by the lens distortion are expressed as (u, v), and the normalized coordinates which have been affected by the lens distortion are expressed as (u^{˜}, v^{˜}), the following equations are given.

u^{˜}=u+u(k₁r²+k₂r⁴)

v^{˜}=v+v(k₁r²+k₂r⁴)

r²=u²+v²

In these equations, u^{˜} is u tilde and v^{˜} is v tilde. k₁ and k₂ are coefficients of a polynomial expressing the lens distortion, which is caused by radial distortion, in the normalized coordinates (u^{˜}, v^{˜}) which have been affected by the lens distortion with respect to the normalized coordinates (u, v) which have not been affected by the lens distortion, and are constants inherent in the lens. When the center of the radial distortion in the coordinates which have not been affected by the lens distortion is expressed as a principal point (xo, yo), there is a relationship given by the following equations.

i(x)=x+(x−xo)(k₁r²+k₂r⁴)

i(y)=y+(y−yo)(k₁r²+k₂r⁴)

where x0 and y0 are constants inherent in the lens. By using these relational expressions, the coordinates (x, y) which have not been affected by the lens distortion can be transformed into the coordinate (i(x), i(y)) which have been affected by the lens distortion.

The projection function arithmetic operation unit 11 performs a function h according to the projection method determined on the basis of projection method information inputted thereto from the parameter storage unit 4 on the coordinates (i(x), i(y)) which have undergone the lens distortion and which is outputted from the lens distortion function arithmetic operation unit 10 to transform the coordinates (i(x), i(y)) into coordinates (h(i(x)), h(i(y))) which have undergone projection distortion. The function h according to the projection method functionally shows how far from the lens center light incident upon the lens with an angle of θ is focused. The function h according to the projection method has the following relationship when the focal length of the lens is expressed as f, the angle of incidence of the incident light, i.e., the half angle of view is expressed as θ, and the image height on the imaging surface of the camera is expressed as Y. In the case of stereographic projection, the function h has the following relationship: Y=2 f tan (θ/2), in the case of equidistant projection, the function h has the following relationship: Y=fθ, in the case of equisolidangle projection, the function h has the following relationship: Y=2f sin(θ/2), and, in the case of orthogonal projection, the function h has the following relationship: Y=f sin θ. Therefore, by transforming the value i(x) of the coordinates (i(x), i(y)) which have undergone the lens distortion and which are outputted from the lens distortion function arithmetic operation unit 10 into the angle of incidence of θ to the lens, and then substituting this angle into the above-mentioned projection equation, a value h (i(x)) which has undergone the projection distortion is acquired. Similarly, by transforming the value i(y) of the coordinates (i(x), i(y)) which have undergone the lens distortion into the angle of incidence of θ to the lens, and then substituting this angle into the above-mentioned projection equation, a value h(i(y)) is acquired. By doing in the above-mentioned way, the projection function arithmetic operation unit can acquire the coordinates (h(i(x)), h(i(y))) which have undergone the projection distortion.

The projection plane transformation function arithmetic operation unit 12 performs a projection plane transformation function f determined on the basis of the mounting information inputted thereto from the parameter storage unit 4 on the coordinates (h(i(x)), h(i(y))) which have undergone the projection distortion and which are outputted from the projection function arithmetic operation unit 11 to transform the coordinates (h(i(x)), h(i(y))) into coordinates (f(h(i(x))), f(h(i(y)))) which have undergone a projection plane transformation (i.e. an imaging surface transformation). The projection plane transformation is the one of adding an influence caused by the mounting state of the camera including the mounting position and the mounting angle of the camera to the camera image captured by the camera because the mounting state of the camera has an influence on the camera image. The projection plane transformation function f is expressed by a geometrical function which has, its coefficients, the height L of the mounting position of the camera with respect to the ground surface, the mounting vertical angle phi which is the degree of inclination angle of the optical axis of the camera with respect to a vertical line, the mounting horizontal angle of θ which is the degree of inclination angle of the optical axis of the camera with respect to a center line extending in a direction of the length of the vehicle, and the distance H which is the amount of displacement of the camera from the center of the width of the vehicle. It is assumed that the camera is not displaced towards a direction of tilt rotation having the optical axis of the camera as the axis of rotation, and is mounted precisely.

The image output function arithmetic operation unit 13 performs an image output function g determined on the basis of the angle of view information and the screen size information which are inputted thereto from the parameter storage unit 4 on the coordinates (f(h(i(x))), f(h(i(y)))) which have undergone the projection plane transformation to transform the coordinates (f(h(i(x))), f(h(i(y)))) into coordinates for image output (g(f(h(i(x)))), g(f(h(i(y))))). Because the size of the camera image captured by the camera generally differs from that of an image which can be displayed on the display unit 5, the size of the camera image is changed into a size which can be displayed on the display unit 5. To this end, the image output function arithmetic operation unit 13 carries out a transformation process corresponding to a change of the size of the camera image to a size which can be displayed on the display unit 5 on the coordinates (g(f(h(i(x)))), g(f(h(i(y))))) which have undergone the projection plane transformation so that the transformed image can have a scale matching that of the camera image. The image output transformation function g is expressed by a mapping function which has, as its coefficients, a maximum horizontal angle of view Xa and a maximum vertical angle of view Ya of the camera, and a maximum horizontal drawing pixel size Xp and a maximum vertical drawing pixel size Yp in the image output.

In the example explained above, the arithmetic operations are carried out on the coordinates showing each point of intersection of graduation lines in the order of the one with the lens distortion function, the one with the projection function, the one with the projection plane transformation function, and the one with the image output function. However, the order in which the functions are performed on the coordinates showing each point of intersection of graduation lines is not limited to the above-mentioned one.

The projection plane transformation function f in the projection plane transformation function arithmetic operation unit 12 further includes the angle of view of the camera (the maximum horizontal angle of view Xa and the maximum vertical angle of view Ya of the camera) as the screen size information showing the size of the captured camera image. Therefore, even when extracting and displaying a part of the camera image, the camera distance measurement device can display the graduation lines in such a way that the graduation lines fit on the extracted part of the camera image by changing the coefficients of the angle of view of the camera in the projection plane transformation function f.

The image correcting unit 6 determines a function i−1 which is the inverse of the lens distortion function i on the basis of the lens distortion information on the camera of the camera unit 3, and performs the inverse function on the camera image captured by the camera unit 3. Because the camera image captured by the camera unit 3 is affected by the lens distortion, the image correcting unit can correct the camera image to provide a camera image which has not been affected by the lens distortion by performing the lens distortion inverse function i−1 on the camera image captured by the camera unit.

The coordinate information which defines the graduation lines which have undergone the transformation processes in the above-mentioned way is outputted from the distance measurement arithmetic operation unit 2 to the line drawing unit 7 as graduation line information. The line drawing unit 7 creates a graduation line image in which a plurality of graduation lines are arranged in such a way as to intersect at right angles in the form of a grid on the basis of the graduation line information.

The image correcting unit 6 then determines a function h−1 which is the inverse of the projection function h on the basis of the projection method information, and performs the inverse function on the camera image on which the lens distortion inverse function arithmetic operation has been performed. Because the camera image captured by the camera unit 3 has undergone the distortion due to the projection method for use in the lens, the image correcting unit can correct the camera image to provide a camera image which has not been affected by the projection distortion by performing the projection inverse function h−1 on the camera image captured by the camera unit.

The image superimposing unit 8 superimposes the graduation line image on the corrected camera image as images in different layers in such a way that the graduation line image drawn by the line drawing unit 7 is superimposed on the camera image corrected by the image correcting unit 6. The display unit 5 performs the image output function g on the corrected camera image among the graduation line image and the corrected camera images located in the different layers to change the size of the corrected camera image to a size which the display unit 5 can display thereon. The display unit then superimposes the graduation line image on the corrected camera image whose size has been changed to create a composite image and then displays this composite image. Because any object in the camera image is affected by the lens distortion, the projection method, and the mounting state of the camera, the distance measurement arithmetic operation unit 2 can display the graduation lines which fit the camera image by carrying out the coordinate transformations corresponding to the lens distortion, the projection method, and the mounting state of the camera on the camera image.

FIG. 3 is a view showing an example of the graduation line image. Referring to FIG. 3, straight lines Lia are graduation lines running at right angles to a direction of the width of the vehicle, and correspond to the straight lines L1 shown in FIG. 2. Straight lines L2a to L5a are graduation lines running in parallel with the direction of the width of the vehicle, and correspond to the straight lines L2a to L5a shown in FIG. 2. The camera image in which the lens distortion and the distortion due to the projection method are removed through the above-mentioned processes carried out by the distance measurement arithmetic operation unit 2, and the graduation lines which are superimposed on the camera image in such a way as to fit the camera image are displayed on the display unit 5.

Each of grid blocks formed by the straight lines L1a to L5a has a side extending in a direction of the width of the vehicle and having a predetermined distance (e.g. 0.50 meters) and a side extending in a direction (a depth direction) vertical to the direction of the width of the vehicle and having a predetermined distance (e.g. 0.50 meters), as shown in FIG. 3. Therefore, the user is enabled to visually recognize the distance from the vehicle to any object with the graduation lines displayed on the display unit 5. Although even a conventional camera distance measurement device can display graduation lines showing the distance from the vehicle to an object in a depth direction, no conventional camera distance measuring device can correctly display graduation lines showing the distance from the vehicle to an object in a direction of the width of the vehicle because distortion in a lateral direction occurs in the camera image due to the lens distortion of the camera. In contrast with this, because the camera distance measurement device in accordance with this Embodiment 1 can remove the lens distortion and the distortion due to the projection method by using the distance measurement arithmetic operation unit 2, the camera distance measurement device in accordance with this Embodiment 1 can also display the distance in a direction of the width of the vehicle correctly on the display screen of the display unit 5.

FIG. 4 is a view showing another example of the graduation line image. Referring to FIG. 4, straight lines L1a-1 are graduation lines showing the width of a parking lot, and the distance between the straight lines L1a-1 is the width of the parking lot. Further, straight lines L1a-2 are graduation lines showing the width of the vehicle, and the distance between the straight lines L1a-2 is the width of the vehicle. Straight lines L2a to L5a are graduation lines running in parallel with a direction of the width of the vehicle, and correspond to the straight lines L2a to L5a shown in FIG. 2. Because the graduation lines are arranged in this way, the camera distance measurement device can correctly provide the distance from the vehicle to an object in a direction of the width of the vehicle, and enables the driver to also use the graduation lines as lines for guiding the driver to perform a parking operation.

As mentioned above, the camera distance measurement device in accordance with this Embodiment 1 includes: the parameter storage unit 4 for storing mounting information showing the mounting position and the mounting angle at and with which the camera is mounted to the vehicle, angle of view information showing the angle of view of the camera, projection method information showing the projection method for use in the lens of the camera, and screen size information showing the screen size of the display unit as parameter information; the distance measurement arithmetic operation unit 2 for performing the process of correcting distortion of the lens of the camera on the position coordinates in the real space of each of grid points defined by the plurality of graduation lines which are arranged in the form of a grid and at intervals of the unit distance, and for transforming the position coordinates of each of the grid points in which the distortion of the lens has been corrected into position coordinates in the camera image on the basis of the mounting information, the angle of view information, the projection method information, and the screen size information which are read from the parameter storage unit 4 to create graduation line information; the line drawing unit 7 for arranging the plurality of graduation lines on the basis of the graduation line information in such a way that they are intersecting at right angles in the form of a grid to create a graduation line image; the image correcting unit 6 for performing the correcting process of removing the distortion of the lens of the camera in the camera image and the distortion caused by the projection method; and the image superimposing unit 8 for superimposing the graduation line image created by the line drawing unit 7 on the camera image corrected by the image correcting unit 6 to output the camera image on which the graduation line image is superimposed to the display unit 5. Because the camera distance measurement device is constructed in this way, the camera distance measurement device can present a graduation line image which enables the user to easily estimate the distance to an object in the camera image.

### Embodiment 2

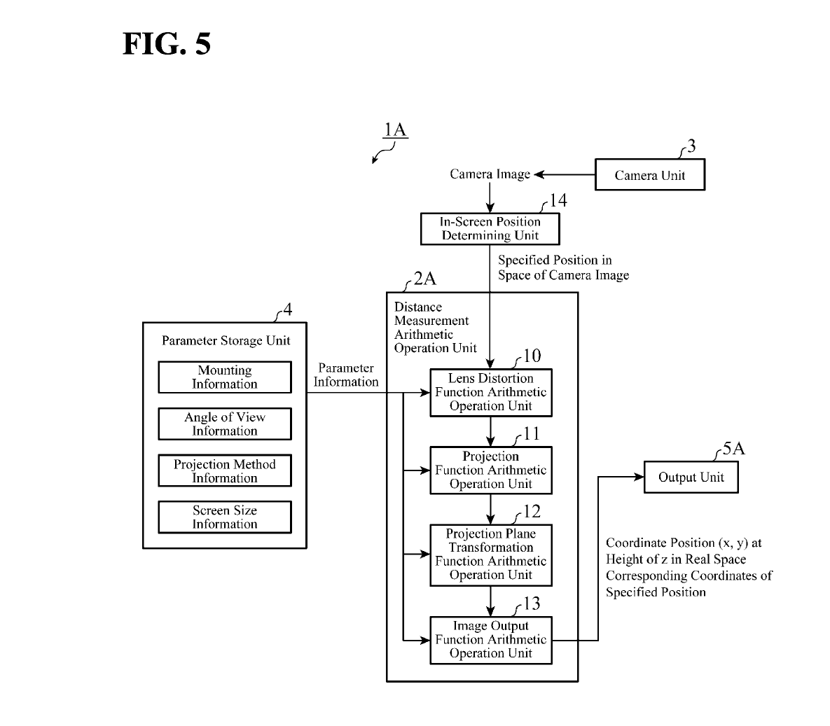

FIG. 5 is a block diagram showing the structure of a camera distance measurement device in accordance with Embodiment 2 of the present invention. Referring to FIG. 5, the camera distance measurement device 1A is provided with a distance measurement arithmetic operation unit 2A, a camera unit 3, a parameter storage unit 4, an output unit 5A, and an in-screen position determining unit 14. The distance measurement arithmetic operation unit 2A is a component for transforming an arbitrary coordinate position in a camera image which is specified by the in-screen position determining unit 14 into a position on a ground surface in real space to calculate the distance from a vehicle to the position, and is provided with a lens distortion function arithmetic operation unit 10, a projection function arithmetic operation unit 11, a projection plane transformation function arithmetic operation unit 12, and an image output function arithmetic operation unit 13.

The output unit 5A is a component for outputting the distance from the vehicle to the position which is calculated by the distance measurement arithmetic operation unit 2A, and is comprised of a display unit which is a display or a sound output unit for notifying the distance by voice. The in-screen position determining unit 14 is a component for specifying an arbitrary position in the camera image displayed on the screen. For example, the in-screen position determining unit can be comprised of an input processing unit for displaying a pointer on the screen to enable the user to specify an arbitrary position by using the pointer, or a touch panel disposed on the screen on which the camera image is displayed.

Next, the operation of the camera distance measurement device will be explained. When the user specifies an arbitrary position on the camera image displayed on the screen by using the in-screen position determining unit 14, the coordinates (u, v) of the specified position in the space of the camera image are inputted to the distance measurement arithmetic operation unit 2A. The lens distortion function arithmetic operation unit 10 of the distance measurement arithmetic operation unit 2A performs a lens distortion function i on the coordinates (u, v) of the position on the camera image specified by the in-screen position determining unit 14 to transform the coordinates into coordinates (i(u), i(v)) which have undergone lens distortion. The lens distortion function i represents the distortion which the camera image which is acquired when the camera of the camera unit 3 has captured an object undergoes due to the shape of the lens of the camera, that shown in above-mentioned Embodiment 1. For example, the lens distortion function i can be determined by using the Zhang model related to the lens distortion. In this model, the lens distortion is modeled as radial distortion, and, when the ideal image coordinates which have not been affected by the lens distortion are expressed as (u, v) T, the observation image coordinates which have been affected by the lens distortion are expressed as (u^{˜}, v^{˜}) T, the ideal normalized coordinates which have not been affected by the lens distortion are expressed as (x, y)T, and the observation normalized coordinates which are affected by the lens distortion are expressed as (x^{˜}, y^{˜})T, the following equations are given.

x^{˜}=x+x(k₁r²+k₂r⁴)

y^{˜}=y+y(k₁r²+k₂r⁴)

r²=x²+y²

In these equations, x^{˜} is x tilde, y^{˜} is y tilde, u^{˜} is u tilde, and v^{˜} is v tilde. k₁ and k₂ are coefficients of a polynomial expressing the lens distortion, which is caused by radial distortion, in the normalized coordinates (x^{˜}, y^{˜})T which have been affected by the lens distortion with respect to the normalized coordinates (x, y)T which have not been affected by the lens distortion, and are constants inherent in the lens. When the center of the radial distortion in the coordinates which have not been affected by the lens distortion is expressed as a principal point (uo, vo) T, there is a relationship given by the following equation.

u^{˜}=u+(u−uo)(k₁r₂+k₂r⁴)

v^{˜}=v+(v−vo)(k₁r²+k₂r⁴)

where u0 and v0 are constants inherent in the lens. By using these relational expressions, the position (u, v) of an object in the space of the camera image can be transformed into the position coordinates (x, y) (=(i(u), i(v))) of the object in the real space.

The projection function arithmetic operation unit 11 performs a function h according to a projection method determined on the basis of projection method information inputted thereto from the parameter storage unit 4 on the coordinates (i(x), i(y)) which have undergone the lens distortion and which is outputted from the lens distortion function arithmetic operation unit 10 to transform the coordinates (i(x), i(y)) into coordinates (h(i(x)), h(i(y))) which have undergone projection distortion. The function h according to the projection method functionally shows how far from the lens center light incident upon the lens with an angle of θ is focused. The function h according to the projection method has the following relationship when the focal length of the lens is expressed as f, the angle of incidence of the incident light, i.e., the half angle of view is expressed as θ, and the image height on the imaging surface of the camera is expressed as Y. In the case of stereographic projection, the function h has the following relationship: Y=2 f tan(θ/2), in the case of equidistant projection, the function h has the following relationship: Y=fθ, in the case of equisolidangle projection, the function h has the following relationship: Y=2f sin(θ/2), and, in the case of orthogonal projection, the function h has the following relationship: Y=f sin θ. Therefore, by transforming the value i(u) of the coordinates (i(u), i(v)) which have undergone the lens distortion and which are outputted from the lens distortion function arithmetic operation unit 10 into the angle of incidence of θ to the lens, and then substituting this angle into the above-mentioned projection equation, the value h(i(u)) which has undergone the projection distortion is acquired. Similarly, by transforming the value i(v) of the coordinates (i(u), i(v)) which have undergone the lens distortion into the angle of incidence of θ to the lens, and then substituting this angle into the above-mentioned projection equation, the value h(i(v)) is acquired. By doing in the above-mentioned way, the projection function arithmetic operation unit can acquire the coordinates (h(i(u)), h(i(v))) which have undergone the projection distortion.

The projection plane transformation function arithmetic operation unit 12 performs a projection plane transformation function f determined on the basis of mounting information inputted thereto from the parameter storage unit 4 on the coordinates (h(i(u)), h(i(v))) which have undergone the projection distortion and which are outputted from the projection function arithmetic operation unit 11 to transform the coordinates (h(i(u)), h(i(v))) into coordinates (f(h(i(u))), f(h(i(v)))) which have undergone a projection plane transformation (i.e. an imaging surface transformation). The projection plane transformation is the one of adding an influence caused by the mounting state of the camera including the mounting position and the mounting angle of the camera to the camera image captured by the camera because the mounting state of the camera has an influence on the camera image. The projection plane transformation function f is expressed by a geometrical function which has, its coefficients, the height L of the mounting position of the camera with respect to the ground surface, the mounting vertical angle phi which is the degree of inclination angle of the optical axis of the camera with respect to a vertical line, the mounting horizontal angle of θ which is the degree of inclination angle of the optical axis of the camera with respect to a centerline extending in a direction of the length of the vehicle, and the distance H which is the amount of displacement of the camera from the center of the width of the vehicle. It is assumed that the camera is not displaced towards a direction of tilt rotation having the optical axis of the camera as the axis of rotation, and is mounted precisely.

The image output function arithmetic operation unit 13 performs an image output function g determined on the basis of angle of view information and screen size information which are inputted thereto from the parameter storage unit 4 on the coordinates (f(h(i(u))), f (h(i(v)))) which have undergone the projection plane transformation to transform the coordinates (f(h(i(u))), f (h(i(v)))) into coordinates for image output (g(f(h(i(u)))), g(f(h(i(v))))). The image output function arithmetic operation unit 13 carries out a transform process corresponding to a change of the size of the camera image to a size which can be displayed on the display unit on the coordinates (g(f(h(i (u)))), g(f(h(i (v))))) which have undergone the projection plane transformation so that the transformed image can have a scale matching that of the camera image. The image output transformation function g is expressed by a mapping function which has, as its coefficients, a maximum horizontal angle of view Xa and a maximum vertical angle of view Ya of the camera, and a maximum horizontal drawing pixel size Xp and a maximum vertical drawing pixel size Yp in the image output.

In the example explained above, the arithmetic operations are carried out on the coordinates showing each point of intersection of graduation lines in the order of the one with the lens distortion function, the one with the projection function, the one with the projection plane transformation function, and the one with the image output function. However, the order in which the functions are performed on the coordinates showing each point of intersection of graduation lines is not limited to the above-mentioned one.

The projection plane transformation function f in the projection plane transformation function arithmetic operation unit 12 further includes the angle of view of the camera (the maximum horizontal angle of view Xa and the maximum vertical angle of view Ya of the camera) as the screen size information showing the size of the captured camera image. Therefore, even when extracting and displaying a part of the camera image, the camera distance measurement device can display the graduation lines in such a way that the graduation lines fit on the extracted part of the camera image by changing the coefficients of the angle of view of the camera in the projection plane transformation function f. As a result, the camera distance measurement device can carry out interconversion between a position in the two-dimensional space of the camera image and a position in the three-dimensional real space whose height as one dimension thereof is fixed. Because the camera distance measurement device can thus carry out interconversion between the two-dimensional space of the camera image and the three-dimensional real space, the camera distance measurement device enables the user to determine an arbitrary position in the camera image by using the in-screen position determining unit 14 to present a corresponding position in the real space to the user on the basis of the camera image.

After the distance measurement arithmetic operation unit 2A calculates the position in the real space corresponding to the position in the camera screen which is specified by the in-screen position determining unit 14 (the coordinate position at a height of z in the real space), the output unit 5A provides this calculated value for the user. For example, in the case in which the output unit 5A is constructed of a sound output unit, the output unit outputs the position calculated by the distance measurement arithmetic operation unit 2A by voice. As an alternative, in the case in which the output unit 5A is constructed of a display unit for displaying the camera image captured by the camera unit 3, the output unit displays the distance from the vehicle to the position on the display screen with characters or brings a color into correspondence with the distance and displays the distance in the color, thereby enabling the user to visually recognize the distance.

As mentioned above, the camera distance measurement device in accordance with this Embodiment 2 includes: the parameter storage unit 4 for storing mounting information showing the mounting position and the mounting angle at and with which the camera is mounted to the vehicle, angle of view information showing the angle of view of the camera, projection method information showing a projection method for use in the lens of the camera, and screen size information showing the screen size of the display unit as parameter information; the in-screen position determining unit 14 for determining a position in the camera image displayed on the display unit; the distance measurement arithmetic operation unit 2A for performing the process of correcting the distortion of the lens of the camera on the coordinates of the position in the space of the camera image determined by the in-screen position determining unit 14, and for transforming the position coordinates in which the distortion of the lens has been corrected into position coordinates at a predetermined height from a ground surface in the real space on the basis of the mounting information, the angle of view information, the projection method information, and the screen size information which are read from the parameter storage unit to create position information; and the output unit 5A for outputting the distance from the position in the camera image determined by the in-screen position determining unit 14 to the vehicle on the basis of the position information. Because the camera distance measurement device is constructed in this way, the camera distance measurement device can recognize the distance to an object from the vehicle by transforming an arbitrary position in the camera image to a coordinate position at a height of z (e.g. at the height from the ground surface to the camera) in real space.

### Embodiment 3

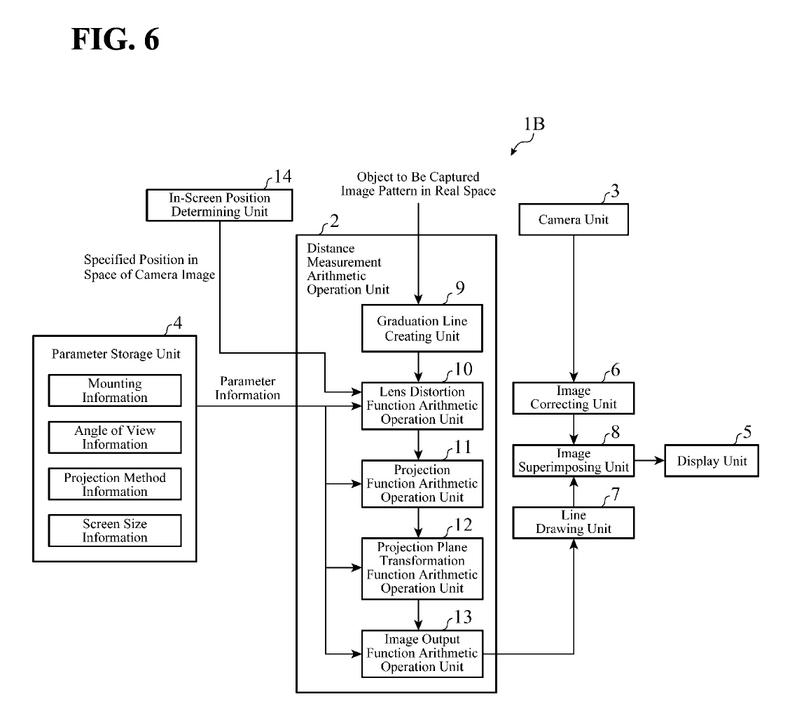

In Embodiment 3, a structure having a combination of those according to above-mentioned Embodiments 1 and 2 will be shown. FIG. 6 is a block diagram showing the structure of a camera distance measurement device in accordance with Embodiment 3 of the present invention. Referring to FIG. 6, the camera distance measurement device 1B has a structure which is a combination of those shown in FIGS. 1 and 2. While the camera distance measurement device displays a graduation line image on a display unit 5, like that according to above-mentioned Embodiment 1, the camera distance measurement device determines an arbitrary position in the graduation line image by using an in-screen position determining unit 14, and transforms the arbitrary position to a coordinate position at a height of z in real space (e.g. the height from a ground surface to a camera), like that according to above-mentioned Embodiment 2.

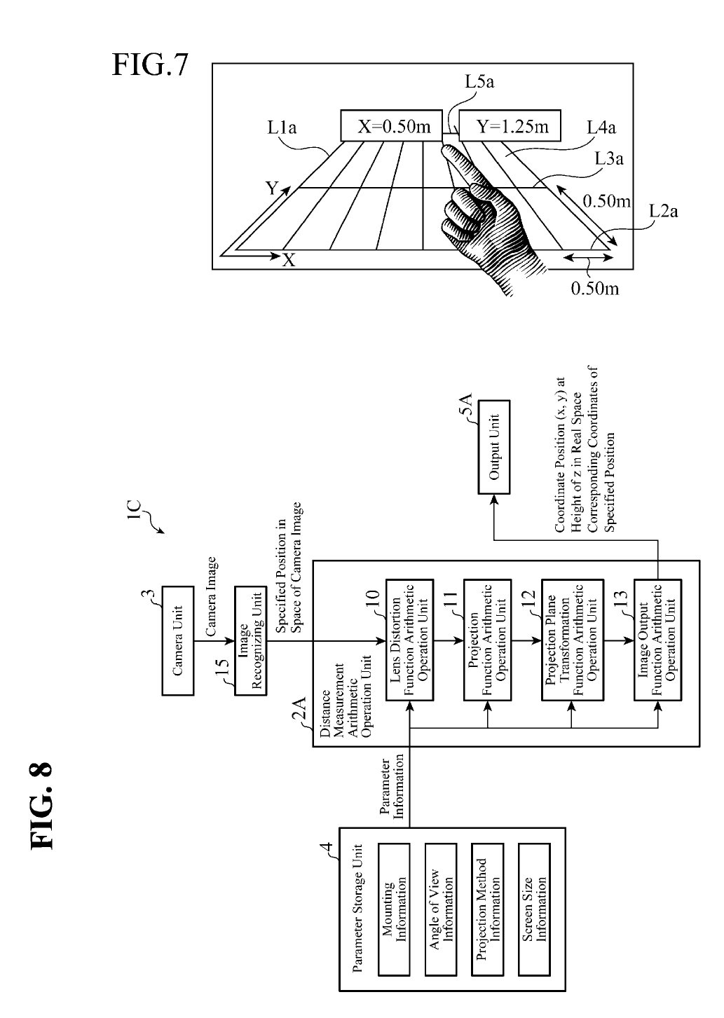

FIG. 7 is a view showing an example of the graduation line image in accordance with Embodiment 3. Referring to FIG. 7, each of grid blocks formed by straight lines L1a to L5a has a side extending in a direction of the width of a vehicle and having a predetermined distance (e.g. 0.50 meters) and a side extending in a direction (a depth direction) vertical to the direction of the width of the vehicle and having a predetermined distance (e.g. 0.50 meters), like in above-mentioned Embodiment 1. Further, a touch panel disposed in a display unit 5 for displaying the graduation line image is used as the in-screen position determining unit 14 so that the camera distance measurement device enables the user to specify an arbitrary position on the graduation line image by using the in-screen position determining unit, as shown in FIG. 7, and can determine the distance from the vehicle to the position. The display unit 5 can display the distance computed by a distance measurement arithmetic operation unit 2 on the screen thereof with characters. In the example of FIG. 7, a distance in a direction of an x-axis is defined with respect to a straight line L5a corresponding to the center of the width of the vehicle, and a distance in a direction of a y-axis is defined on the basis of the predetermined distance in the depth direction of each grid block. The arbitrary point specified in the figure has a distance of 0.50 meters in the direction of the x-axis from the center of the width of the vehicle, and a distance of 1.25 meters in the direction of the y-axis (in the depth direction). By doing in this way, the camera distance measurement device enables the user to visually recognize the distance from the vehicle.

The camera distance measurement device can display such a graduation line image as shown in FIG. 4 to enable the user to specify an obstacle existing in a parking lot by using the in-screen position determining unit 14 when parking the vehicle in the parking lot, and display the distance between the obstacle and the vehicle.

As mentioned above, the camera distance measurement device in accordance with this Embodiment 3 includes the in-screen position determining unit 14 for determining a position in the camera image displayed on the display unit 5 in addition to the structure according to above-mentioned Embodiment 1, and performs the process of correcting the distortion of the lens of the camera on the coordinates of the position in the space of the camera image determined by the in-screen position determining unit 14, and transforms the position coordinates in which the distortion of the lens has been corrected into position coordinates at a predetermined height from a ground surface in the real space on the basis of the mounting information, the angle of view information, the projection method information, and the screen size information which are read from the parameter storage unit 4 to create position information, and the display unit 5 outputs the distance from the position in the camera image determined by the in-screen position determining unit 14 to the vehicle on the basis of the position information. Because the camera distance measurement device is constructed in this way, the camera distance measurement device can transform an arbitrary position in the graduation line image to a coordinate position at a height of z (e.g. at the height from the ground surface to the camera) in the real space to enable the user recognize the distance from the vehicle to the position while presenting the graduation line image which can facilitate the measurement of the distance to an object in the camera image.

### Embodiment 4

FIG. 8 is a block diagram showing the structure of a camera distance measurement device in accordance with Embodiment 4 of the present invention. The camera distance measurement device 1C is provided with an image recognizing unit 15 as the in-screen position determining unit 14 shown in above-mentioned Embodiment 2. The image recognition section 15 is a component for carrying out image recognition on a specific object (an obstacle) displayed on a display screen to determine the coordinate position of the object on a camera image. For example, when supporting the driver during parking, the camera distance measurement device recognizes an obstacle existing in a parking lot by using an existing image recognition technique to determine the coordinates of the position of the obstacle on the camera image. By processing these position coordinates by using a distance measurement arithmetic operation unit 2A, the camera distance measurement device can present the distance between the obstacle and the vehicle to the driver.

Although in the example shown in FIG. 8 the structure in which the image recognizing unit 15 is disposed as the in-screen position determining unit 14 shown in above-mentioned Embodiment 2 is shown, the camera distance measurement device can be alternatively constructed in such a way as to include the image recognizing unit 15 as the in-screen position determining unit 14 having the structure which is explained by making a reference to FIG. 6 in above-mentioned Embodiment 3.

As mentioned above, because the camera distance measurement device in accordance with this Embodiment 4 includes the image recognizing unit 15 for detecting the position of an object in the camera image by carrying out image recognition on the camera image, the camera distance measurement device can determine an arbitrary position (the position of an obstacle) in the camera image according to the image recognition on the camera image, thereby being able to easily estimate the distance to the obstacle in the camera image.

### INDUSTRIAL APPLICABILITY

Because the camera distance measurement device in accordance with the present invention can measure the distance to an object in the camera image, the camera distance measurement device can be applied effectively to a parking support device or the like which uses a rear camera having an image capture range in a backward direction behind a vehicle.

1. A camera distance measurement device for displaying an image in which a plurality of graduation lines which are arranged in a form of a grid with respect to a vehicle are superimposed on a camera image which is captured by a camera mounted to the vehicle on a display unit to measure a distance in a direction of a width of said vehicle and a distance in a direction of the capturing by said camera from a unit distance defined for each grid side of said graduation lines, said camera distance measurement device comprising:
a parameter storage unit for storing mounting information showing a mounting position and a mounting angle at and with which said camera is mounted to said vehicle, angle of view information showing an angle of view of said camera, projection method information showing a projection method for use in a lens of said camera, and screen size information showing a screen size of said display unit as parameter information;
a distance measurement arithmetic operation unit for performing a process of correcting distortion of the lens of said camera on position coordinates in real space of each of grid points defined by said plurality of graduation lines which are arranged in the form of a grid and at intervals of said unit distance, and for transforming the position coordinates of each of the grid points in which the distortion of said lens has been corrected into position coordinates in said camera image on a basis of said mounting information, said angle of view information, said projection method information, and said screen size information which are read from said parameter storage unit to create graduation line information;
a line drawing unit for arranging said plurality of graduation lines on a basis of said graduation line information in such a way that they are intersecting at right angles in a form of a grid to create a graduation line image;
an image correcting unit for performing a correcting process of removing the distortion of the lens of said camera in said camera image and distortion caused by said projection method; and
an image superimposing unit for superimposing said graduation line image created by said line drawing unit on said camera image corrected by said image correcting unit to output said camera image on which said graduation line image is superimposed to said display unit.

2. A camera distance measurement device for displaying a camera image which is captured by a camera mounted to a vehicle on a display unit to measure a distance from a position in said camera image to said vehicle, said camera distance measurement device comprising:
a parameter storage unit for storing mounting information showing a mounting position and a mounting angle at and with which said camera is mounted to said vehicle, angle of view information showing an angle of view of said camera, projection method information showing a projection method for use in a lens of said camera, and screen size information showing a screen size of said display unit as parameter information;
an in-screen position determining unit for determining a position in said camera image displayed on said display unit;
a distance measurement arithmetic operation unit for performing a process of correcting distortion of the lens of said camera on coordinates of the position in space of the camera image determined by said in-screen position determining unit, and for transforming the position coordinates in which the distortion of said lens has been corrected into position coordinates at a predetermined height from a ground surface in real space on a basis of said mounting information, said angle of view information, said projection method information, and said screen size information which are read from said parameter storage unit to create position information; and
an output unit for outputting a distance from the position in said camera image determined by said in-screen position determining unit to said vehicle on a basis of said position information.

3. The camera distance measurement device according to claim 1, wherein said camera distance measurement device includes an in-screen position determining unit for determining a position in said camera image displayed on said display unit, and wherein said distance measurement arithmetic operation unit performs the process of correcting the distortion of the lens of said camera on coordinates of the position in space of the camera image determined by said in-screen position determining unit, and transforms the position coordinates in which the distortion of said lens has been corrected into position coordinates at a predetermined height from a ground surface in real space on a basis of said mounting information, said angle of view information, said projection method information, and said screen size information which are read from said parameter storage unit to create said position information, and said display unit outputs a distance from the position in said camera image determined by said in-screen position determining unit to said vehicle on a basis of said position information.

4. The camera distance measurement device according to claim 2, wherein said in-screen position determining unit is an image recognizing unit for detecting a position of an object in said camera image by carrying out image recognition on said camera image.
